(19) United States
(12) Patent Application Publication
(10) Pub. No.: US 2005/0111677 A1
(43) Pub. Date: May 26, 2005

(54) Acoustic drive arrays and loudspeakers incorporating same

(75) Inventors: Alastair James Mackenzie Brown, Langbank (GB); Philip William Hobbs, Glasgow (GB); Simon Edward Roper, Glasgow (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Linn Products Limited

(21) Appl. No.: 10/803,432

(22) Filed: Mar. 18, 2004

(30) Foreign Application Priority Data
Mar. 21, 2003 (GB) 0306552.1

(51) Int. Cl. H04R 25/00; H04R 3/00

(52) U.S. Cl. 381/182; 381/160

(57) ABSTRACT

An array of acoustic drive units providing controlled high frequency dispersion and very low acoustic coloration. The array comprises mounting means for supporting a midrange acoustic drive unit and at least one high frequency acoustic drive unit, and an acoustically reflective surface. The high frequency drive unit is disposed in front of the reflective surface, the configuration of the reflective surface and the disposition of the high frequency drive unit relative thereto being such as to substantially eliminate any coherent reflection of sound from the high frequency drive unit. The reflective surface is generally concave, its outer periphery having a convex, curved cross section providing a smooth convex transition between the main reflective surface and its outermost edge. Typically, the reflective surface has a generally elliptical periphery and a quasi-ellipsoidal configuration, without focal points, and may incorporate or comprise a low frequency acoustic drive unit.

### BACKGROUND OF THE INVENTION

The present invention seeks to provide arrays of acoustic drive units that provide controlled high frequency dispersion and very low acoustic coloration, such that loudspeakers incorporating the arrays can have a variety of cabinet configurations and can be placed in a variety of locations, including locations near to walls or rebated into wall surfaces, without changing the dispersion characteristics of the loudspeaker. The invention further seeks to optimise dispersion and lobing (at crossover) characteristics.

### FIELD OF THE INVENTION

The present invention relates to arrays of acoustic drive units, particularly midrange and high frequency acoustic drive units, and to loudspeakers incorporating such arrays. The drive units are preferably integrated into a self-contained assembly that may or may not further include an additional low frequency drive unit, and that can be incorporated into a variety of loudspeaker cabinets, with or without additional drive units, in a variety of different specifications and configurations.

### SUMMARY OF THE INVENTION

In accordance with a first aspect of the invention there is provided an acoustic drive array comprising mounting means for supporting a midrange acoustic drive unit and at least one high frequency acoustic drive unit and means defining an acoustically reflective surface, said mounting means being arranged in a fixed, predetermined spatial relationship with said reflective surface such that said at least one high frequency drive unit is disposed in front of said reflective surface, the configuration of the reflective surface and the disposition of the at least one high frequency drive unit relative thereto being such as to substantially eliminate any coherent reflection of sound from the at least one high frequency drive unit.

Preferably, the reflective surface is irregular and continuously varying, in terms of the distance from the periphery of the reflective surface to the at least one high frequency drive unit and the angle between the reflective surface and a plane in which the drive units of the array are mounted.

More preferably, the shortest distance from the centre of the at least one high frequency drive unit to any point on the periphery of the reflective surface is 30 mm or greater, and the largest distance from the centre of the at least one high frequency drive unit to any point on the periphery of the reflective surface is 155 mm or less.

Preferably, the reflective surface is generally concave. Preferably also, the outer periphery of the reflective surface has a convex, curved cross section to provide a smooth convex transition between the main reflective surface and its outermost edge.

In preferred embodiments, the reflective surface has a generally elliptical periphery and a quasi-ellipsoidal configuration, without focal points.

In certain embodiments, the reflective surface incorporates a low frequency acoustic drive unit. In other embodiments, the reflective surface comprises a low frequency acoustic drive unit.

In preferred embodiments, the array includes first and second high frequency drive units.

In preferred embodiments, the mounting means includes a first portion supporting the midrange drive unit and an arm portion extending from said first portion and supporting the at least one high frequency drive unit, whereby the at least one high frequency drive unit is cantilevered in front of the reflective surface.

Preferably, the mounting means comprises an air-tight, sealed enclosure. Preferably also, the mounting means is configured to minimise the baffle area surrounding the drive units. Preferably also, the baffle area is configured to curve away and rearwards from the drive units.

Preferably, the means defining the reflective surface comprises a reflector member. Preferably also, the reflector member is secured to the mounting means to provide an integrated, self-contained drive array.

In accordance with a second aspect of the invention, there is provided a loudspeaker comprising a cabinet having an acoustic drive array in accordance with the first aspect of the invention mounted therein.

Preferably, the loudspeaker includes at least one low frequency drive unit in addition to the drive units of the array.

It is known in the prior art to mount high frequency drive units in a supporting structure that bridges a low frequency drive unit so that the high frequency drivers are disposed in front of the low frequency drive unit. However, such prior arrangements do not provide a reflective surface behind the high frequency drive units having the advantageous acoustic properties provided by the present invention.

### BRIEF DESCRIPTION OF THE DRAWING

Embodiments of the invention will now be described, by way of example only, with reference to the accompanying drawings, in which:

FIGS. 1 and 2 are, respectively, schematic sectional side and plan views of an acoustic drive array embodying the invention;

FIG. 3 is a front perspective view of a preferred embodiment of a rear drive unit enclosure component of the array of FIGS. 1 and 2;

FIG. 4 is a front perspective view of a preferred embodiment of a front drive unit mounting component (frame) of the array of FIGS. 1 and 2;

FIGS. 5A and 5B are, respectively, front and rear perspective views of a preferred embodiment of an acoustic reflector component of the array of FIGS. 1 and 2;

FIGS. 6A and 6B are, respectively, rear and front views of the reflector of FIGS. 5A and 5B, and FIG. 6C is a section on line A-A of FIG. 6B;

FIGS. 7A and 7B are, respectively, front and rear views of the frame of FIG. 4, and FIGS. 7C-7E are, respectively, sections on lines A-A, B-B and C-C of FIGS. 7A and 7B;

FIGS. 8A and 8B are, respectively, front and rear views of the component of FIG. 3, and FIGS. 8C-8E are, respectively, sections on lines A-A, B-B and C-C of FIG. 8A.

### DETAILED DESCRIPTION OF THE PREFERRED EMBODIMENTS

Referring now to the drawings, an acoustic drive array 10 in accordance with one aspect of the invention comprises a midrange drive unit 12 and at least one high frequency drive unit 14 or 16, but more preferably two (or more) high frequency drive units: a tweeter 14 and a super-tweeter 16. The drive units 12-16 are preferably mounted in a single mounting component or frame 18, having apertures 20, 22 and 24 for receiving the drive units 12-16. The frame 18 is in turn mounted to a rear enclosure component 26 that, together with the frame 18 and drive units 12-16, defines a sealed, air-tight enclosure assembly 27, comprising a first chamber portion 28, including the midrange driver 12, and an arm portion 30 extending outwardly from the main chamber portion 28 and including the high frequency driver(s) 14, 16.

The enclosure assembly 27 is arranged in a fixed, predetermined spatial relationship with means defining a concave acoustic reflector 32, such that the one or more high frequency drive units 14, 16 are cantilevered in front of the reflector 32 by the arm portion 30. The enclosure assembly is sufficiently rigid to prevent any significant vibration of the arm portion in normal use. The frame 18, component 26 and reflector 32 may be made from die-cast aluminium, or from any other suitable metals, alloys or plastics.

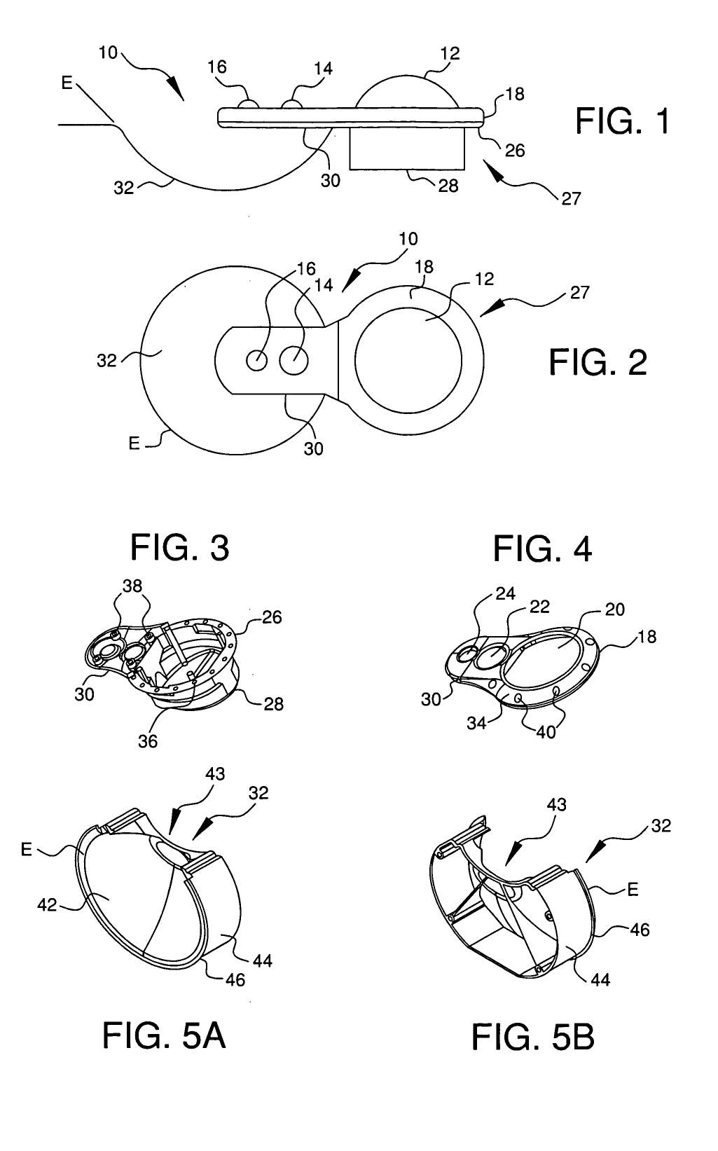

The characteristics of the reflector surface and its relationship to the high frequency driver(s) 14, 16, illustrated only schematically in FIGS. 1 and 2, is discussed in more detail below. In general terms, the reflector 32 is rebated into the cabinet of a loudspeaker incorporating the driver array and acts as an acoustic diffuser, so that the array as a whole simulates as closely as possible the acoustic dispersion characteristics of a high frequency driver mounted in an ideal spherical enclosure, and so that these dispersion characteristics are maintained regardless of the configuration of the loudspeaker cabinet.

The reflector 32 defines an acoustically reflective surface behind the high frequency drive unit(s) 14, 16 such that the high frequency directivity of the loudspeaker is precisely controlled and rendered insensitive to the effects of loudspeaker placement (relative to the walls or other reflecting surfaces of the listening room). This means that the loudspeaker can be placed near to walls, or rebated into a wall surface, without changing the dispersion characteristics of the loudspeaker.

The reflector 32 presents a reflective surface that is irregular and continuously varying, in terms of the distance from the periphery of the reflector to the high frequency drive unit(s) and the angle between the reflective surface and the plane in which the drive units are mounted. This arrangement substantially eliminates any coherent reflections of sound from the high frequency driver(s) that would interfere with the direct sound. Sound from the high frequency driver(s) is reflected from the reflector in a multiplicity of different directions, so that the sum of the various reflections at any listening point and any given frequency is effectively zero.

The arm portion 30 of the enclosure assembly is in front of the reflector 32, so that the effect of the reflector is to control rearward dispersion from the high frequency drivers without compromising forward dispersion.

The arm portion 30 is configured to minimise the baffle area on which the high frequency drivers are mounted, so that the effective radiating area at high frequencies is reduced. This has the effect of maximising the horizontal and vertical dispersion of the loudspeaker at high frequencies, reducing acoustic coloration (providing a more open, natural sound) and enhancing image sharpness for arrays of two or more loudspeakers (stereo pairs, “surround-sound” arrays, etc.).

The reflector is configured and the high frequency drivers arranged such that the majority of reflections are from the peripheral edge E of the reflector 32. The arrangement is effective for all frequencies where the shortest distance d from the sound source (i.e. the centre of the high frequency driver) to a point on the peripheral edge E is equal to or greater than half a wavelength at that frequency. For example, if d=80 mm, then the reflector would be effective for all frequencies above 2 kHz. For practical purposes, the minimum useful size for the reflector would be where the distance d is about 30 mm. The effect of the reflector reduces as the largest distance of the peripheral edge E from the centre of the high frequency driver increases, becoming negligible when this distance approaches 155 mm or less.

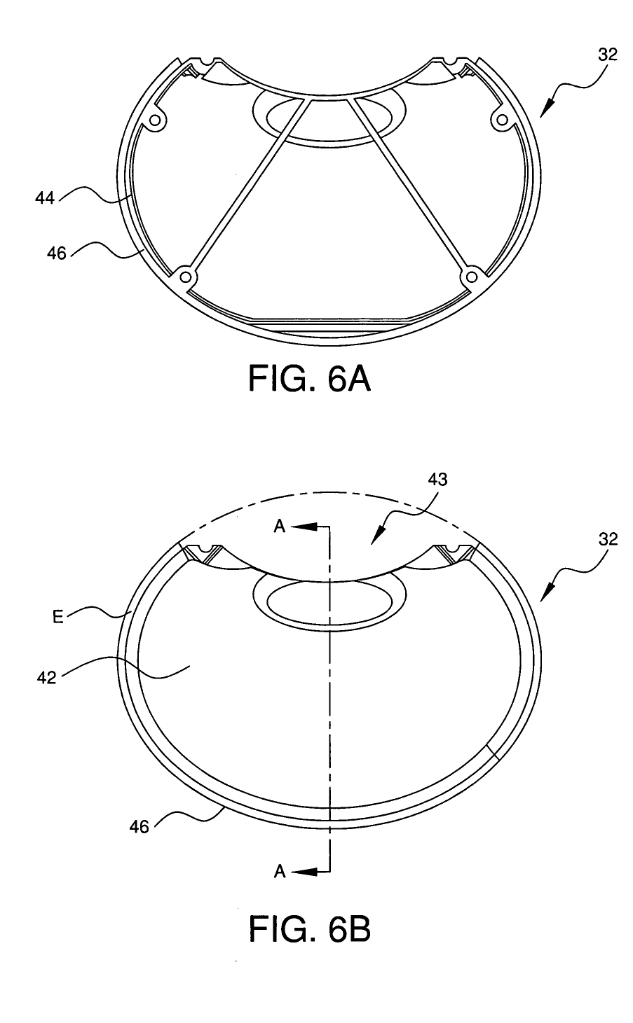

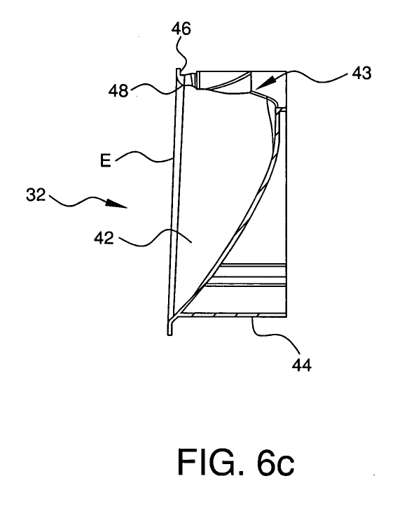

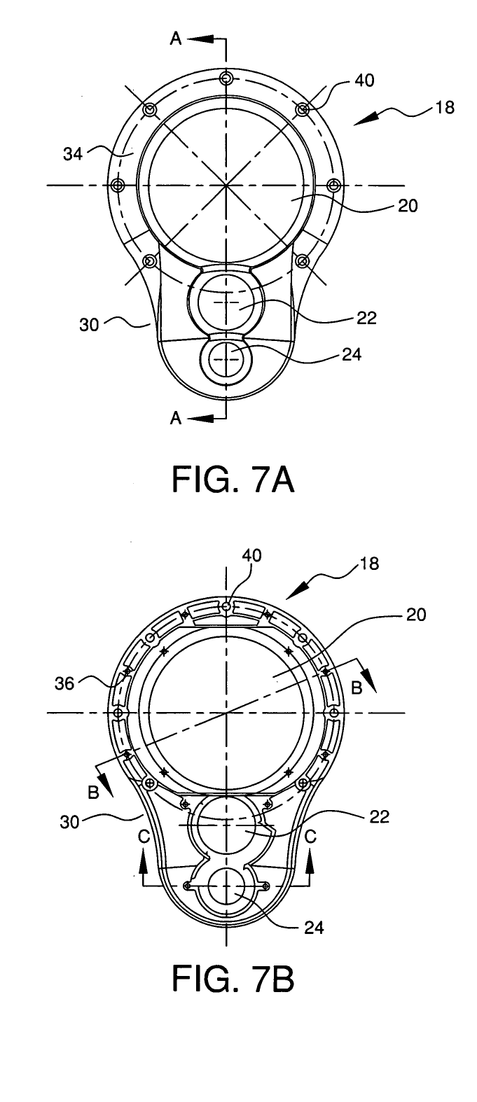

FIGS. 3 to 6 illustrate particularly preferred embodiments of the frame 18, rear enclosure component 26 and the reflector 32. The interior of the component 26 is configured to accommodate the rear portions of the drive units 12, 14 and 16 when these are mounted in the frame 18 and the frame is mated with the component 26. The front surface 34 of the frame 18 is generally convex, so that the surface curves away and rearwards from the drive units, while locating the drive units as close together as possibly and minimising the baffle area surrounding the units.

The frame 18 and component 26 further include various apertures and bores 36, 38, 40 and the like whereby they may be fastened together and the enclosure assembly 27 may be mounted in a loudspeaker cabinet by means of screws, bolts etc.

The reflector 32 defines a generally concave reflecting surface 42 with a side wall 44 and a peripheral flange 46 that would abut against the front wall of a loudspeaker cabinet, in use. The reflective surface 42 has a cutaway portion 43 to receive part of the chamber portion 28 of the rear enclosure component 26. The reflector 32 is preferably secured to the assembled frame 18 and component 26 and drive units to provide an integrated, self-contained driver array for mounting in any of a variety of loudspeaker cabinets.

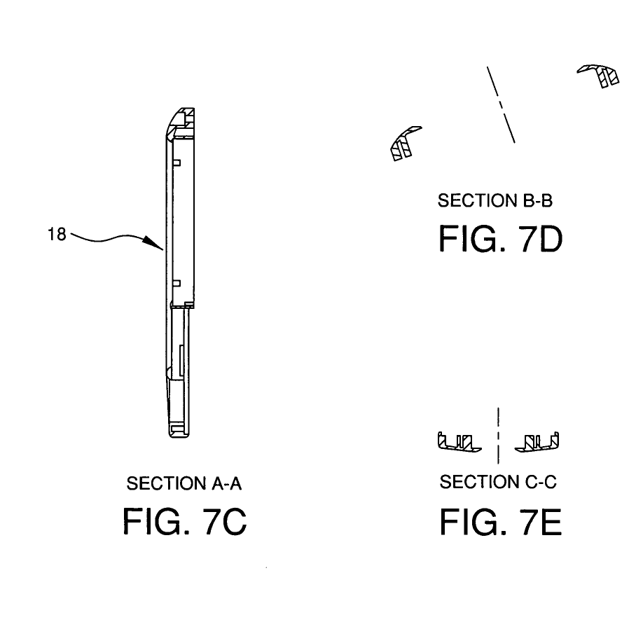

In this embodiment, as best seen in FIGS. 6A-6C, the reflector 32 is generally elliptical in plan and the reflector surface 42 has a quasi-ellipsoidal configuration, by which it is meant that the surface can be regarded as an ellipsoidal surface distorted to remove any focal points. It will be understood that the shape of the reflector periphery and/or surface may be varied as long as they have the required effect of diffusing reflected sound from the high frequency drivers 14, 16.

In order to ensure that reflections from the peripheral edge E of the reflector are diffused effectively, the surface 42 is radiused around its periphery to provide a smooth, convex transition between the main concave surface and the outermost edge. Preferably, the radius of curvature is of the order of 7 mm.

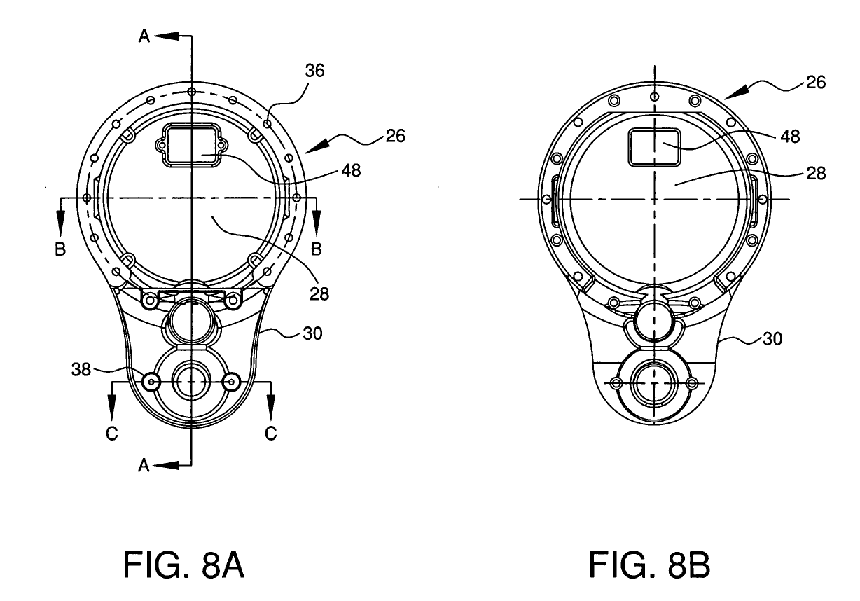

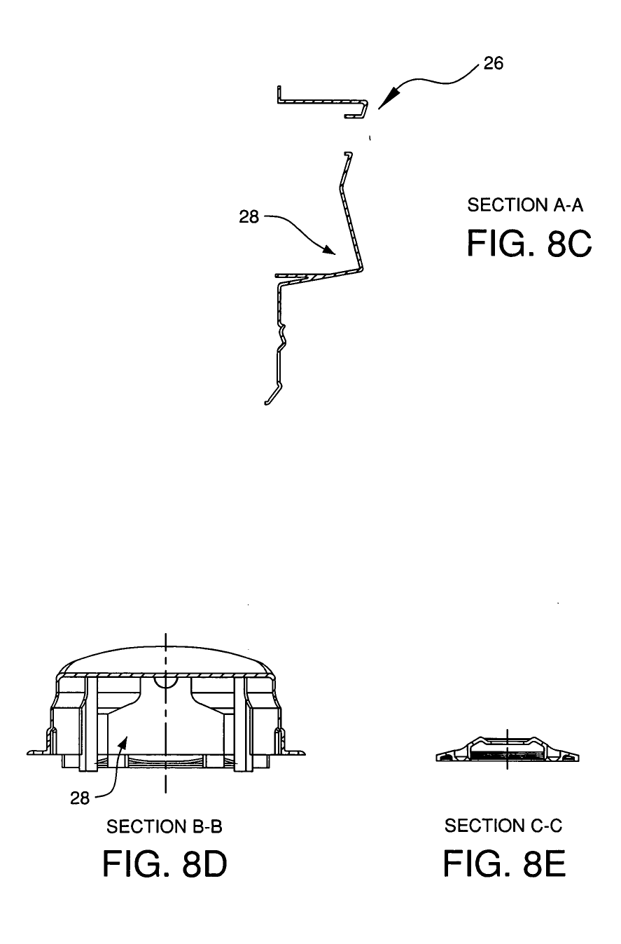

FIGS. 7 and 8 illustrate the preferred embodiments of the frame 18 and component 26 in more detail. Note the wiring port 48 in the rear surface of the chamber portion 28 of component 26.

In the embodiment illustrated, the array comprising the assembly 27 and the reflector 32 includes the midrange drive unit 12 and high frequency drive unit(s) 14, 16. However, the array can be modified to include at least one low frequency drive unit that may be mounted in the reflector 32, or which itself may be configured to act as the reflector 32 (replacing the reflector). Where a low frequency driver is mounted in the reflector, the boundary between the outer periphery of the driver and the surface of the reflector may be configured to optimise the dispersion characteristics of the low frequency driver, in a manner that is known in the art. Where a low frequency driver replaces the reflector, the required edge characteristics of the reflector (such as the radiusing 48 referred to above) may be obtained by means of a suitably configured trim ring fitted to the periphery of the driver or by suitable design of the periphery of the driver itself.

Acoustic drive arrays in accordance with the invention can be incorporated into a variety of types of loudspeaker cabinets which may or may not include one or more additional drive units (normally low frequency drive units). Where the array includes its own low frequency driver, the array may be mounted in a cabinet without additional drive units to provide a complete loudspeaker. Whether or not the array includes its own low frequency driver, one or more additional low frequency drivers may be included in the loudspeaker. Loudspeakers incorporating the array, and/or audio systems incorporating such loudspeakers, may have any of a variety of well known crossover arrangements and/or wiring configurations.

The invention provides the basis for a family of loudspeakers employing similar acoustic drive arrays in accordance with the invention such that all members of the family have substantially identical midrange and high frequency acoustic characteristics.

Improvements and modifications may be incorporated without departing from the scope of the invention.

1. An acoustic drive array comprising mounting means for supporting a midrange acoustic drive unit and at least one high frequency acoustic drive unit and means defining an acoustically reflective surface, said mounting means being arranged in a fixed, predetermined spatial relationship with said reflective surface such that said at least one high frequency drive unit is disposed in front of said reflective surface, the configuration of the reflective surface and the disposition of the at least one high frequency drive unit relative thereto being such as to substantially eliminate any coherent reflection of sound from the at least one high frequency drive unit.

2. An acoustic drive array as claimed in claim 1, wherein the reflective surface is irregular and continuously varying, in terms of the distance from the periphery of the reflective surface to the at least one high frequency drive unit and the angle between the reflective surface and a plane in which the drive units of the array are mounted.

3. An acoustic drive array as claimed in claim 1, wherein the shortest distance from the centre of the at least one high frequency drive unit to any point on the periphery of the reflective surface is 30 mm or greater, and the largest distance from the centre of the at least one high frequency drive unit to any point on the periphery of the reflective surface is 155 mm or less.

4. An acoustic drive array as claimed in claim 1, wherein the reflective surface is generally concave.

5. An acoustic drive array as claimed in claim 4, wherein the outer periphery of the reflective surface has a convex, curved cross section to provide a smooth convex transition between the main reflective surface and its outermost edge.

6. An acoustic drive array as claimed in claim 1, wherein the reflective surface has a generally elliptical periphery and a quasi-ellipsoidal configuration, without focal points.

7. An acoustic drive array as claimed in claim 1, wherein the reflective surface incorporates a low frequency acoustic drive unit.

8. An acoustic drive array as claimed in claim 1, wherein the reflective surface comprises a low frequency acoustic drive unit.

9. An acoustic drive array as claimed in claim 1, wherein the array includes first and second high frequency drive units.

10. An acoustic drive array as claimed in claim 1, wherein the mounting means includes a first portion supporting the midrange drive unit and an arm portion extending from said first portion and supporting the at least one high frequency drive unit, whereby the at least one high frequency drive unit is cantilevered in front of the reflective surface.

11. An acoustic drive array as claimed in claim 1, wherein the mounting means comprises an air-tight, sealed enclosure.

12. An acoustic drive array as claimed in claim 1, wherein the mounting means is configured to minimise the baffle area surrounding the drive units.

13. An acoustic drive array as claimed in claim 12, wherein the baffle area is configured to curve away and rearwards from the drive units.

14. An acoustic drive array as claimed in claim 1, wherein the means defining the reflective surface comprises a reflector member.

15. An acoustic drive array as claimed in claim 1, wherein the reflector member is secured to the mounting means to provide an integrated, self-contained drive array.

16. A loudspeaker comprising a cabinet having an acoustic drive array in accordance with claim 1 mounted therein.

17. A loudspeaker as claimed in claim 16, including at least one low frequency drive unit in addition to the drive units of the array.
